(19) United States
(12) Patent Application Publication
(10) Pub. No.: US 2008/0011156 A1
(43) Pub. Date: Jan. 17, 2008

(54) Arrangement in Connection with an Oscillator Cylinder

(76) Inventor: Vesa Ropponen, Punkalaidun (FI)

Correspondence Address: STITES & HARBISON PLLC, 1199 NORTH FAIRFAX STREET, SUITE 900, ALEXANDRIA, VA, 22314, US

(21) Appl. No.: 11/719,989

(22) PCT Filed: Nov. 23, 2005
(86) PCT No.: PCT/FI05/00498

§ 371 Date: May 23, 2007

(30) Foreign Application Priority Data
Nov. 23, 2004 (FI) 20041503

(51) Int. Cl. F15B 15/24

(52) U.S. Cl. 92/15

(57) ABSTRACT

An arrangement in combination with an oscillating cylinder (1), whereby the arrangement includes a working valve (10) of cylinder (1) to transmit pressure medium into cylinder (1), impulse valves (5) by means of which, by working valve is controlled, control means (4), as discs, from movable piston rod (18) to cylinder (1) outside, which can be arranged to get in several different linear positions in contact with the control means impulse valves (5) in order to produce a stroke length set for the piston rod of the oscillation cylinder In the arrangement the impulse valves are placed sideways outside control means (4) and the required impact to be achieved from the control means (to the impulse valves (5) is moved by means of special arms (13) moved from control means (4) as an opening/closing motion of the shut-off part of the impulse valves whereby the structural length of the oscillating cylinder can be achieved essentially shorter in the cylinder back end of control means (4), (5).

The invention relates to an arrangement in connection with an oscillator cylinder, whereby the arrangement includes a working valve of the cylinder to transmit pressure medium into the cylinder, impulse valves controlling the change of the oscillation direction, by means of which the working valve is controlled, control means, as discs, from the movable piston rod to the outside of cylinder, which can be arranged in several different linear positions to get in contact with the control means of the impulse valves in order to produce a stroke length set for the cylinder piston rod. The impulse valves are placed sideways to the outside of the control means and the required impact to be achieved from the control means to the impulse valves is moved by means of special arms as a motion opening/closing the shut-off part of the impulse valves.

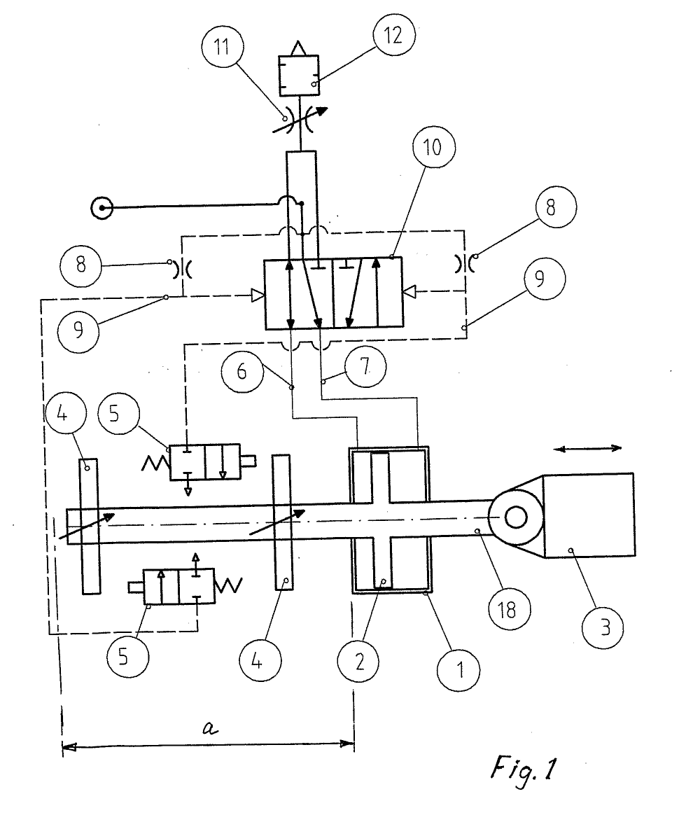

Previously known are oscillating cylinders and valve solutions in combination with them and adjusting means of the oscillating distance, where through the cylinder the piston rod is taken out for the adjusting means of the oscillating distance and the impulse valves beside said piston rod are according to the presentation in FIG. 1. On the piston rod discs adjustable to their location are fitted, due to the locations of which and of joint operation with the impulse valves the oscillation distance can be adjusted. The impulse valves are between the adjustable discs and in this case the piston rod must reach quite far out from the cylinder even by short cylinder length. Accordingly, in known solutions in the cylinder head an equipment shelter must be built at a remarkable distance from the cylinder outward. Control discs adjusting the oscillation length hit directly the peg of the valve spindle, whereby the impulse valves must be between the discs. Usually the discs are remarkably farther from each other than the distance of stroke length set for them. The space requirement of a known control system, which is almost the same as the length of the piston rod in its farthest position from the cylinder (measure a), is obtained adding the impulse valve length+two times the thickness of the guiding disc+two times the stroke length.

In order to remove these disadvantages that increase the structural length of the oscillation cylinder a new arrangement in connection with the oscillation cylinder is developed and the arrangement is characterized in that due to the design of the arms the impulse valves can be placed outside the control means into positions, where they do not increase the structural length of the set piston rod protruding out from the oscillation cylinder, whereby the structural length of the oscillation cylinder can be made essentially shorter in the cylinder end on the side of the control means.

The advantage of the invention is that it is possible to make the structural length of the oscillation cylinder entirety to shorten remarkably, expressly at that part, when the structure is as a harmful protrusion. Especially in combination with paper machines a cylinder installed next to the paper web has to be placed at the frame or supporting structures and in those spots there is hardly any space for a cylinder to be as a protrusion away from the web. When the impulse valves that control the change of oscillation direction are moved off the piston rod side or the side of its extension it has opened surprising possibilities for instance to shorten the distance of control discs to a length shorter than the stroke length set by them. Shortening of the structural length according to the arrangement has no impact on the fitting of valves, service, change or adjustment of stroke length

In the following the invention is disclosed with reference to the enclose drawing, where

FIG. 1 shows schematically a known oscillation cylinder arrangement.

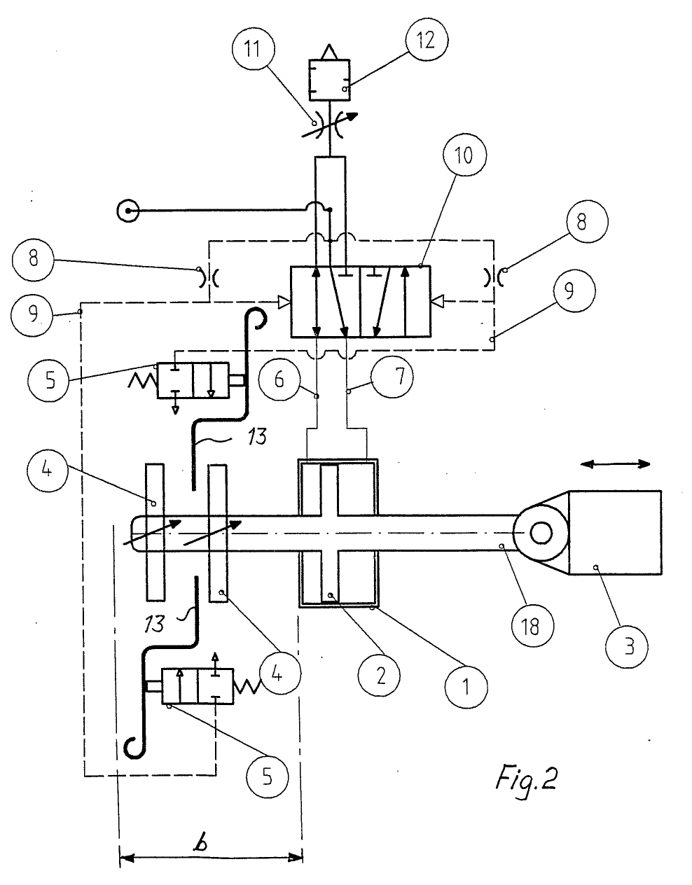

FIG. 2 shows schematically the oscillation cylinder arrangement according to the invention.

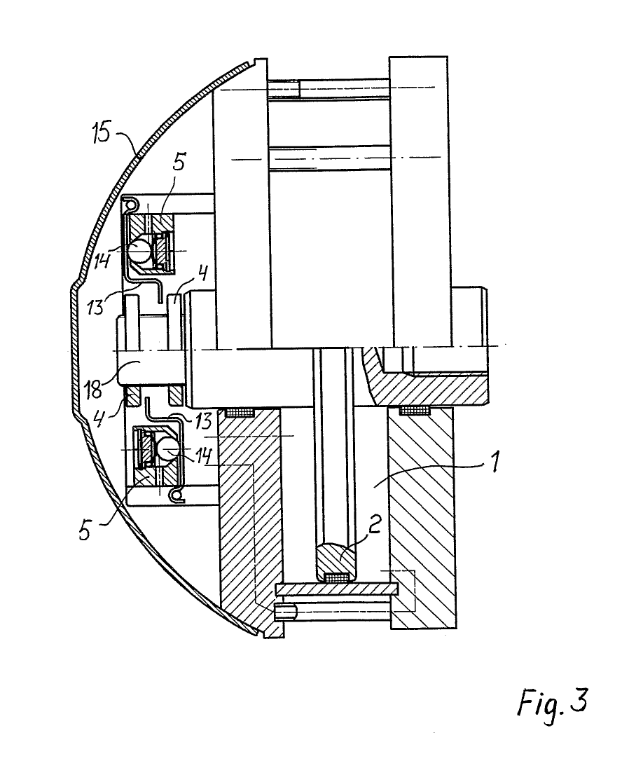

FIG. 3 shows as crosscut of an oscillation cylinder arrangement.

FIG. 1 shows a control diagram of a previously known oscillation cylinder, in which cylinder 1 to piston 2 a moving piston rod 18 is connected, which runs through the cylinders and to the movable actuator or fixing component 3 and further to a device maintaining the adjustment of length of the oscillating motion in other direction. The adjustment of length is done by means of movable discs 4 on piston rod 18. The discs are fixed as such to the rod in a position so that in a wanted rod 2 position they hit the noses of impulse valves 4 placed between the discs. Pushing in the noses of impulse valves 4 opens the of impulse valves to let out the control pressures along line 9 from change valve 10 so that change valve 10 in its turn steers the working pressure into cylinder 1 either along line 6 or along line 7. In line 9 there are also chokers 8. The working out from both sides of rod 2 in turns through control choker 11 and exhaust element 12. By means of control choker 11 the motion speed of rod 2 can be adjusted. The structural length outwards from cylinder 1 is schematically presented by measure a.

FIG. 2 shows a corresponding oscillation cylinder improved according to the arrangement of the invention. Control discs 4 are still on he piston rod but can for adjustment of stroke of a same length as per FIG. 1 be taken quite close to each other. Both impulse valves 5 are moved away from between control discs 4. The motion of control discs 4 is by means of arms 3 transmitted to impulse valves 5. Arms 13 are from their end fixed either stiffly to the equipment body or by means of a joint fixed to turn in the equipment body. However, when control disc 4 hits arm 13 and turns the arm towards the peg of impulse valve spindle, arm 13 presses immediately the peg of the valve spindle and impulse valve 5 opens.

When another control disc 4 hits the arm as arrived from the opposite direction the arm bends or turns along with the disc away from the impulse valve. Thanks to these solutions control discs 4 can be notably closer to each other than the distance of the piston length. Further arm 13 can be made to have folds, whereby thanks to the folds impulse valve 5 can due to the folds still be moved more against the cylinder. Arm 13 is stiff, if it is from its end fixed by means of a joint to the equipment body. If arm 13 is fixed stiff to the equipment body, it is then most suitably made of spring material, whereby it bends a little toward the impulse valve, when valve 4 moves that way and bends more in other direction than another disc is possibly bending it.

FIG. 3 shows an assembly image of an oscillation cylinder 1 short to its structural length according to the invention. Piston 2 has a short piston rod 18, which protrudes from both sides of the cylinder. Control discs 14 are close to each other, and as impulse valves 5 there are ball valves, where arm 13 pushes ball 14, which immediately opens a channel out off the impulse valve. Ball 14 closes the channel straight against the hard counter surface. When ball 14 moves, for instance only about 0.5 mm, a channel already needed past ball 14 opens. Accordingly, for opening impulse valves 5 no motion in the piston rod 18 direction is hardly needed after the arm has reached contact with disc 4. The proper change valve is also placed in a space sheltered with a cover 15. The Round spherical cover 15 is easily removed even if there were hardly any free space seen from the cover to the left.

1. An arrangement in connection with an oscillator cylinder (1), whereby the arrangement includes a working valve (10) of cylinder (1) to transmit pressure medium into cylinder (1), impulse valves (5) controlling the change of oscillation direction, by means of which working valve (10) is controlled, control means (4), as discs, from movable piston rod (18) to cylinder (1) outside, which in several different linear positions can be arranged to get in contact with the control means of impulse valves (5) in order to produce a stroke length set for the cylinder piston rod (18) of the oscillation cylinder (1) and impulse valves (5) are placed sideways outside control means (4) and the required impact to be achieved on impulse valves (5) is moved from control means (4) by means of special arms (13) as a motion opening/closing the shut-off part of the impulse valves, characterized in that thanks to the design of arm (13) the impulse valves (5) can be placed outside the control means into positions, where they do not increase the structural length set by the piston rod protruding from oscillation cylinder (1), whereby they the structural length of oscillation cylinder (1) can be achieved essentially shorter in the cylinder back end of control means (4),(5).

2. An arrangement according to claim 1, characterized in that the arms from their one end are fixed by means of a joint to the equipment body and they are turning levers.

3. An arrangement according to claim 1, characterized in that the arms from their other end are fixed by means of a joint to the equipment body and they are flexible as spring material.

4. An arrangement according to claim 1, characterized in that with regard to the stroke length set for the cylinder the control means, as discs (4) can be placed closer to each other than the stroke length set for the cylinder.

5. An arrangement according to claim 1, characterized in that the shut-off part of the impulse valve is a ball that lets the pressure medium out of valve (5).

6. An arrangement according to claim 1, characterized in that at least the other arm has one or more folds, thanks to witch the location of corresponding impulse valve (5) can be get into a position that shortens the structural length.
